(19) United States
(12) Patent Application Publication
(10) Pub. No.: US 2012/0176493 A1
(43) Pub. Date: Jul. 12, 2012

(54) INSPECTION APPARATUS AND INSPECTION METHOD

(76) Inventors: Nobuaki Hirose, Hitachinaka (JP); Izuo Horai, Adawara (JP)

(21) Appl. No.: 13/391,323

(22) PCT Filed: Sep. 6, 2010
(86) PCT No.: PCT/JP2010/005449

§ 371 Date: Mar. 13, 2012

(30) Foreign Application Priority Data
Sep. 29, 2009 (JP) 2009-233603

(51) Int. Cl. H04N 7/18

(52) U.S. Cl. 348/135; 348/E07.085

(57) ABSTRACT

Disclosed are an inspection apparatus and an inspection method capable of stably acquiring image data of a wafer having a high contrast at alignment marks and the peripheral portions even when a film is formed on a surface of the wafer. Specifically disclosed is a flaw inspecting apparatus which comprises an alignment measuring device including a light source serving as an illuminating light, an imaging optical system that emits light beams from the light source to an object and that collects and focuses the reflected light beams, a camera that is disposed on a converging point in the imaging optical system and that captures images of the object, and an image processing function that processes the captured images. The images are captured using the reflected light beams in at least two different spectral bands, and image information of the object corresponding to the reflected light beams is appropriately computed so that the contrast of alignment marks is increased.

### TECHNICAL FIELD

The present invention relates to an inspection apparatus.

### BACKGROUND ART

For example, so-called foreign substance inspection apparatuses for inspecting defects of semiconductors or the like comprise alignment measuring devices to perform the positioning (alignment) of wafers prior to the inspection. The alignment measuring devices of this kind perform the alignments by irradiating illumination light to the alignment marks on the wafers, acquiring the reflection light by CCD cameras or the like, and measuring the mark positions of the acquired images. For measurement of the mark positions, a method to have stored reference images in advance and to search the stored images from the acquired images is typically known, and as search methods, a method to use correlations and a method to extract and to compare characteristic points are known. Detailed contents are described in PATENT LITERATURE 1.

Alignment marks are searched by comparing the images, therefore, in order to execute the alignment normally, the marks of the acquired images need to have high contrasts compared to their vicinities. Incidentally, as illumination light, white light is often used. Furthermore, with white light, the contrast cannot be obtained in some cases, and as a countermeasure for that, a method to limit wavelength bands is typically known. Limitation methods of the wavelength bands include, for example, a method to insert filters in optical paths as PATENT LITERATURE 2, a method to use color CCD sensors as PATENT LITERATURE 3, a method to change light sources to LEDs with different wavelength bands and to control light quantities for each as PATENT LITERATURE 4, and the like.

### PRIOR ART REFERENCES

### Patent Literatures

[PATENT LITERATURE 1] JP 11-340115 A
[PATENT LITERATURE 2] JP 10-228318 A
[PATENT LITERATURE 3] JP 06-260390 A
[PATENT LITERATURE 4] JP 2006-91623 A

### SUMMARY OF THE INVENTION

### Problems to be Solved by the Invention

Recently, due to higher densities being developed, thicknesses of the films which are piled up in manufacturing processes of lithography have been increased. In the case of deposition film wafers having large film thicknesses described above, there is a problem such that the reflection ratio to the wavelengths varies heavily, and even if a plurality of filters are prepared, by using any of them, contrasts between the alignment marks and the vicinity parts cannot be obtained enough compared to the noises by cameras or optical systems. As a countermeasure for that, there exists a noise reduction by the long time exposures or the addition of images, however it takes more time to acquire images, therefore, it is inevitable that the throughputs are reduced. Moreover, by highly narrowing the band widths of the filters, it is expected that the contrasts are improved, however, as the band widths are being narrowed, light quantities to penetrate the filters are reduced, therefore, long time exposures are essential also for this. In addition, in some cases, due to the subtle unevenness of the film thicknesses, the contrasts cannot be obtained even from wafers of the identical manufacturing process.

As pre-process methods of images used when mark-searching, there exist binarization and normalization of the images, however, in images which are highly noisy, if the binarization alternatively the normalization is adapted as it is, a great number of noises are included, therefore, it is difficult to distinguish the alignment marks and the noises, and it is impossible to detect alignment marks normally.

An object of the present invention, in respect of the aforementioned problem, is to provide an inspection apparatus which can stably obtain contrasts of alignment marks, even in deposition film wafers having large film thicknesses.

### Means to Solve the Problem

A first feature of the present invention is that an inspection apparatus comprises an alignment measuring device, wherein the alignment apparatus comprises a light source for irradiating light to an object, an image-formation optical system for image-forming the light from the object, an imaging device for acquiring images which are image-formed by the image-formation optical system, and an image processing unit for processing images acquired by the imaging device, and wherein the image processing unit heightens contrasts by calculating a plurality of images acquired by detecting the light of at least two different wavelength bands with the imaging device.

A second feature of the present invention is to comprise a light source for emitting light of at least two different wavelength bands for the light source and to detect the light corresponding to the wavelength bands.

A third feature of the present invention is that the calculation-processing does not only have addition but also subtraction.

By this configuration, in the images acquired with different wavelength bands, especially by using two images where the light and the shade are reversed in the alignment marks and vicinity parts, and by subtraction-processing after performing appropriate corrections, it is possible to eliminate background noises and is possible to extract alignment marks only.

A fourth feature of the present invention is that cameras with respect to the present invention independently detect a plurality of wavelength bands such as color cameras or the like.

By this configuration, it is possible to acquire the images of different wavelength bands at the same time, therefore, it is not necessary to switch filters physically and the throughputs are not reduced.

### Effect of the Invention

By the present invention configured as aforementioned, even in wafers where thick films have been piled up or wafers having the unevenness of film thicknesses, it is possible to perform wafer inspections with high reliabilities by making it possible to obtain images of high contrasts.

### BRIEF DESCRIPTION OF THE DRAWINGS

FIG. 1 is a drawing showing a schematic configuration of a foreign substance inspection apparatus with regard to one embodiment of the present invention;

FIG. 2 is a flow chart of an inspection operation with regard to the embodiment of the present invention;

FIG. 3 is a drawing showing a configuration example of an alignment measuring device with regard to the embodiment of the present invention;

FIG. 4 is a drawing showing wavelength characteristics of the reflection ratio of deposition film wafers;

FIG. 5 is an image information selection, calculation-processing registration screen with regard to the embodiment of the present invention;

FIG. 6 is a flow chart showing operations in FIG. 5 in a; and

FIGS. 7A-7C are drawings schematically showing a mark detection method by calculation.

### MODES FOR CARRYING OUT THE INVENTION

An embodiment of the present invention will be explained with reference to the drawings.

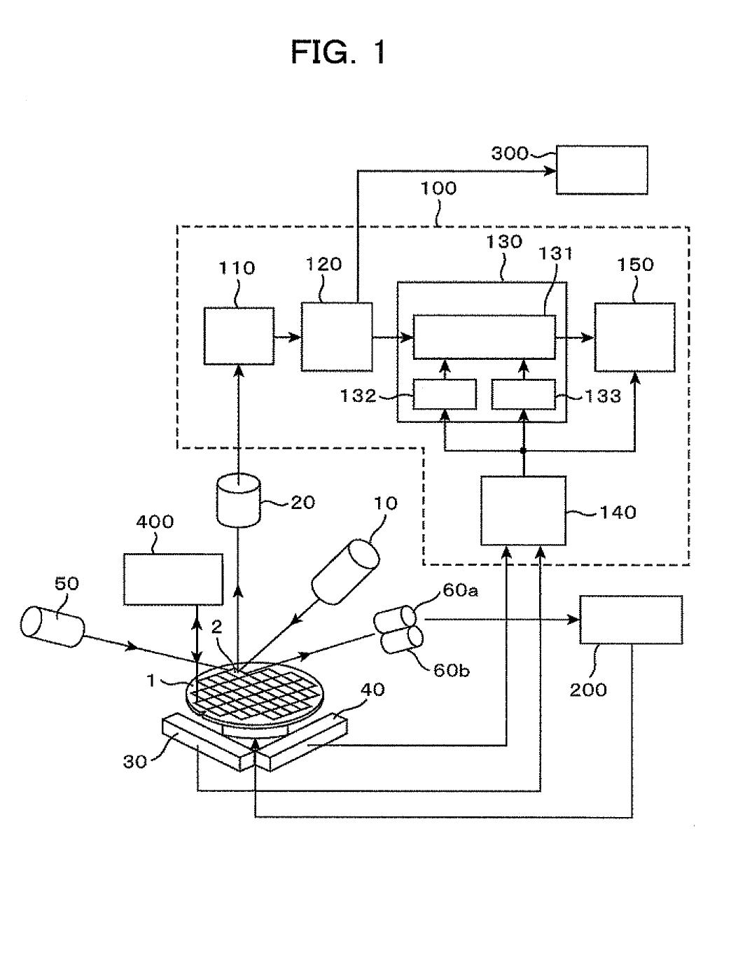

FIG. 1 is a drawing showing a schematic configuration of a foreign substance inspection apparatus with regard to one embodiment of the present invention. The foreign substance inspection apparatus of this embodiment comprises an illumination means 10 of a foreign substance detection system, a detection means 20 (image-formation means 20a, light-receiving means 20b) of the foreign substance detection system, an X scale 30, a Y scale 40, an illumination section 50 of a surface height position detection system, a detection section 60 (2 pieces for 1 set: 60a, 60b) of the surface height position detection system, a processing apparatus 100, a control apparatus 200 of a stage Z, and an image display device 300, an alignment measuring device 400.

A wafer 1 on the surface of which a chip 2 has been formed, when being transferred onto the wafer table (stage Z) (not shown), firstly has offsets of X direction, Y direction and an angle θ correction performed by the alignment measuring device 400.

The illumination means 10 generates laser beams of the specified wavelength as inspection light, and irradiates the light beam to the surface of the wafer 1 which is an inspected object. The light beam irradiated from the laser apparatus 10 scans the surfaces of the wafer 1 as the stage Z moves to the Y direction and the X direction.

That is to say, it is possible to scan the whole surface of the wafer 1 with the inspection light by moving the stage Z to the horizontal direction, lengthwise and breadthwise.

The light-receiving means 20b comprises, for example, TDI (Time Delay and Integration) sensors, CCD sensors, photomultiplier tubes (photo-multipliers) and the like, and receives scattered light which has occurred on the surface of the wafer 1, converts the intensity to electric signals, and outputs to the processing apparatus 100 as image signals.

The X scale 30 and the Y scale 40 comprise, for example, laser scales or the like, detect X direction positions and Y direction positions of the wafer 1 respectively, and output the position information to the processing apparatus 100.

The processing apparatus 100 comprises an A/D converter 110, a foreign substance detection image processing unit 120, a foreign substance determination unit 130, a coordinate control unit 140, and an inspection result storage unit 150.

The A/D converter 110 converts the image signals of analog signals which have been input from the light-receiving means 20b to the image signals of digital signals and outputs.

The foreign substance detection image processing unit 120 includes, for example, a delay circuit and a difference detection circuit. The delay circuit, by inputting the image signals from the A/D converter 110 and delaying, outputs image signals of the chip having already completed the irradiation of the light beam which is a chip being one-chip-previous to the chip to which the light beam is currently being irradiated for scanning by the inspection light.

The foreign substance determination unit 130 includes a determination circuit 131 and coefficient tables 132, 133. In the coefficient tables 132, 133, coefficients for changing thresholds are being made corresponding to the coordinate information and stored.

The coefficient tables 132, 133 input the coordinate information from the coordinate control unit 140 to be described later, and output the coefficients which are being made corresponding to the coordinate information and being stored, to the determination circuit 131.

To the determination circuit 131, a difference of mutual image signals of adjacent chips is input from the foreign substance detection image processing unit 120, and coefficients for changing thresholds are input from the coefficient tables 132, 133.

The determination circuit 131 multiplies the coefficients being input from the coefficient tables 132, 133 by the values specified in advance, and generates thresholds.

Thereafter, the differences of the image signals and the thresholds are compared and in the case that the difference is equal to or greater than the threshold, it is judged that a foreign substance exists, and the inspection result is output to the inspection result storage unit 150.

The determination circuit 131 also outputs the information of the threshold which has been used for the judgment to the inspection result storage unit 150.

The coordinate control unit 140 detects, on the basis of the position information of the wafer 1 which has been input from the X scale 30 and the Y scale 40, the X-coordinate and the Y-coordinate of the position to which the light beam is currently irradiated on the wafer 1, and outputs the coordinate information.

The inspection result storage unit 150 stores the inspection result which has been input from the foreign substance determination unit 130 and the coordinate information which has been input from the coordinate control unit 140 being made corresponding.

The inspection result storage unit 150 also stores the information of the threshold which has been input from the foreign substance determination unit 130 being made corresponding to the inspection result or the coordinate information.

The illumination means 10 of the foreign substance detection system irradiates the inspection light to the inspected object.

The detection means 20 of the foreign substance detection system receives the light which is reflected or scattered from the surface of the inspected object, and detects the optical intensity.

The illumination section 50 of the surface height position detection system irradiates the detection light of the surface height position detection to the inspected object.

The detection section 60 (2 pieces for 1 set: 60a, 60b) of the surface height position detection system detects the surface height position of the inspected object. The surface height position detection means comprises two detection sections which have different detection center positions in the up-and-down direction of the inspected object.

The foreign substance determination unit 130 is referred to as a foreign substance judgment means for inspecting or judging the existence of the foreign substance existing on the surface of the inspected object from the optical intensity data which the optical intensity detection means has detected.

The stage Z control device 200 controls the up-and-down position variation means for moving the stage up-and-down and varying the up-and-down position of the inspected object.

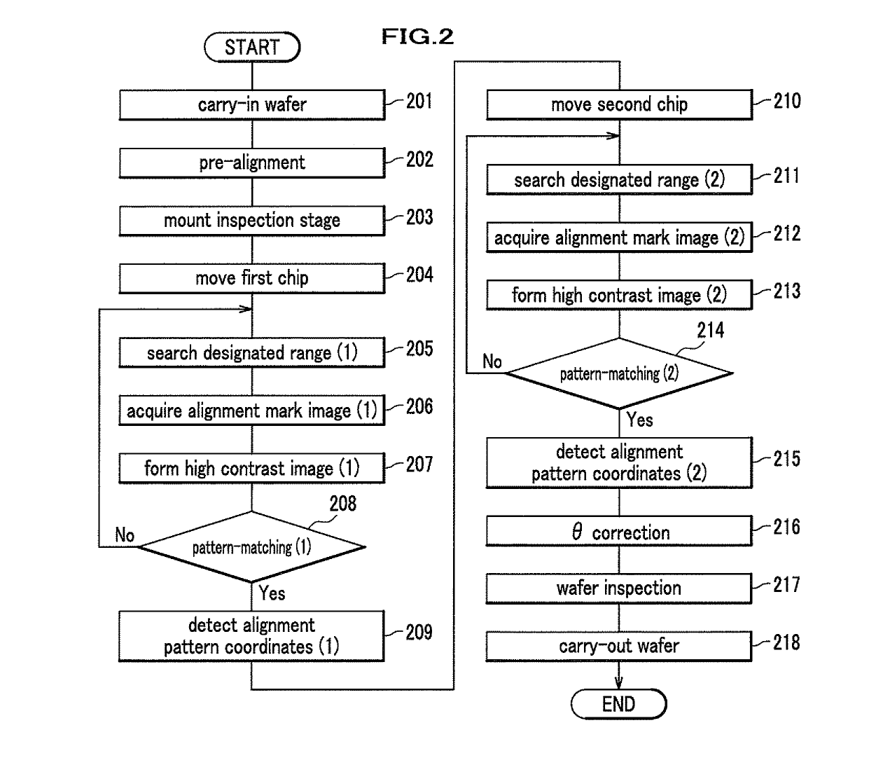

In FIG. 2, a flow when performing the inspection is shown. 203 through 216 are alignment actions.

Here, the alignment measuring device 400 according to this embodiment will be explained.

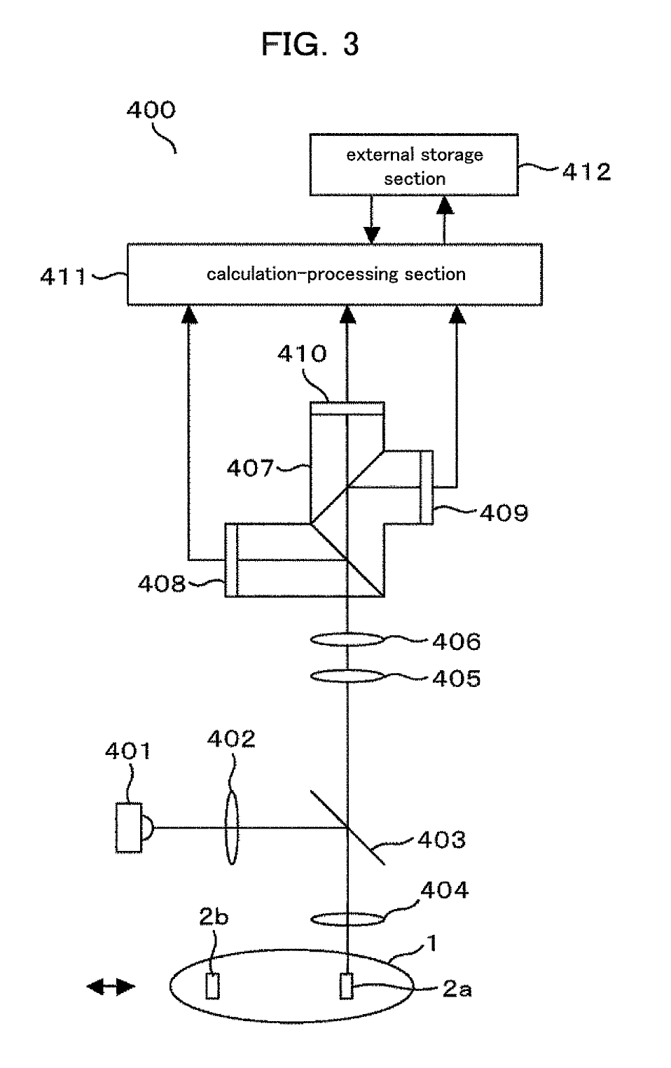

With reference to FIG. 3, the alignment measuring device 400 will be explained. The alignment measuring device 400 is configured to separate the illumination light irradiated to the wafer 1 by using a prism 407 in wavelength bands, and to output the difference of the images acquired per wavelength area. The alignment measuring device 400 comprises a light source 401, an illumination optical system for condensing the illumination light radiated from the light source 401 onto an alignment mark 2a of a first chip and an alignment mark 2b of a second chip of the wafer 1, an image-formation optical system for color-separating the reflection light from the wafer 1 by the prism 407 and condensing to three CCD cameras 408, 409, 410 being one example of the imaging device, a calculation-processing section 411 for calculation-processing the image information acquired in the three CCD cameras 408, 409, 410 and outputting the images being made optimized, and an external storage section 412 for having stored the reference alignment images, and the combinations, the calculation methods.

In this alignment measuring device 400, the illumination light emitted from the light source 401 is converted into the parallel light by the projection lens 402, reflected by a half mirror 403, condensed by a first objective lens 404 and irradiated to the alignment mark 2a of the first chip of the wafer 1. The reflection light reflected by the wafer 1, after being converted into the parallel light by the objective lens 404, and after penetrating the half mirror 403 and being divided into wavelength bands in the prism 407 by a second objective lens 405 and an image-formation lens 406, is image-formed on the image pick-up element of the three CCD cameras 408, 409, 410 and the image information is acquired.

The image information obtained by the CCD cameras 408, 409, 410 is input to the calculation-processing section 411. The calculation-processing section 411 reads out the image selection, calculation methods stored in advance regarding the image information being input from the external storage section 412, calculates correspondingly, and forms the image information having high contrasts. If it is the case that the selection, calculation methods are not stored, a registration is newly made in the method to be explained later. After the image-formation, the formed image information as the measurement images is pattern-matched with the reference alignment mark images stored in the external storage section, and the actual coordinates of the alignment marks are acquired. The coordinates of the alignment marks for two different chips in the wafer 1 are acquired, and the correction (alignment) is made on the coordinate errors in the X direction, the Y direction, and the θ direction by calculation. Subsequently, an explanation will be made regarding the configuration in the case to acquire the images with different wavelength bands and to heighten the contrasts by calculation.

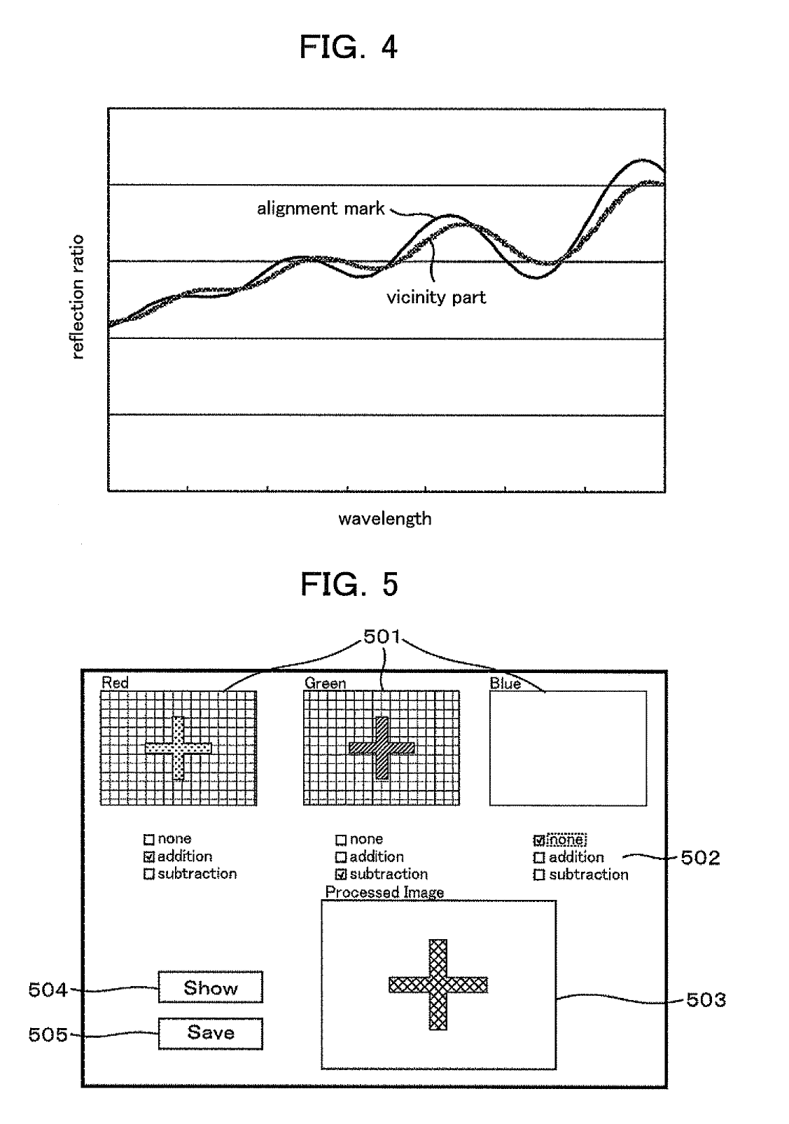

The alignment measuring device 400 which is configured in this way identifies alignment marks and measures utilizing the difference of the reflection ratios of the alignment marks and their vicinity parts, however, in the case that the wafer 1 is a deposition film wafer with the film piled up on the surface such as the oxide film, the nitride film or the like, for example, as shown in FIG. 4, the reflection ratios of the alignment mark 2a of this first chip, the alignment mark 2b of the second chip, and their vicinity parts periodically vary depending on the film thicknesses and the wavelengths, and the magnitude correlation is reversed. In other words, there are cases that the light and shade of the alignment marks and their vicinity parts are reversed by the wavelengths in the acquired images.

Due to the variation and the reverse of the light and shade depending on these wavelengths, the light with wider wavelength bands causes a greater reduction of the contrast, therefore, is possible to heighten the contrast by selecting the illumination light wavelengths which enlarge the reflection ratio difference of the alignment marks and the vicinity parts and giving the characteristics which are close to the single wavelength, however, in the actual processes, the film thicknesses are not completely uniform, accordingly, there has been a problem that the measurement cannot be made due to some degree of the unevenness of the film thicknesses.

Therefore, this embodiment can obtain contrasts stably, even if the film thicknesses are different to some degree, by acquiring a plurality of pieces of image information of the different penetration wavelengths and calculation-processing among the images with respect to two or more images including the light and shade of the alignment marks and their vicinity parts which have been reversed.

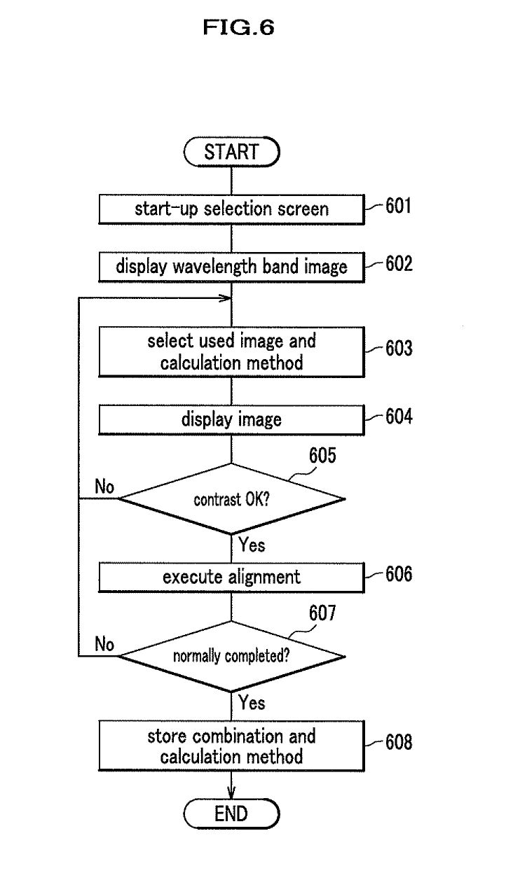

With reference to FIG. 5, the registration of selection, and calculation methods of the combination will be explained. When a wafer in a certain process is inspected, in the case that the combination of the wafer is not set, or in the case that the user has selected the re-set, a screen such as FIG. 5 is displayed. On the screen, an acquired image 501 in each frequency component is displayed, and the user, while looking at the image, selects either of no use of the image information, addition, or subtraction, by using a check box 502 under the image. After the selection, when the button of 504 is depressed, an image after the calculation is displayed in the part 503. If it is the case that the user has determined that the image of the part 503 has contrasts enough high, when the button of 505 is depressed, if the alignment action is executed and completed normally, the combination is stored in the external store apparatus 412 and the operation is completed. If it is the case that the user has felt that the contrast of the part 503 is insufficient, or the case that the alignment is failed, by selecting the 502, depressing the 504 again, a calculation image in a new combination is displayed on 503. The above is shown in a flow chart as FIG. 6.

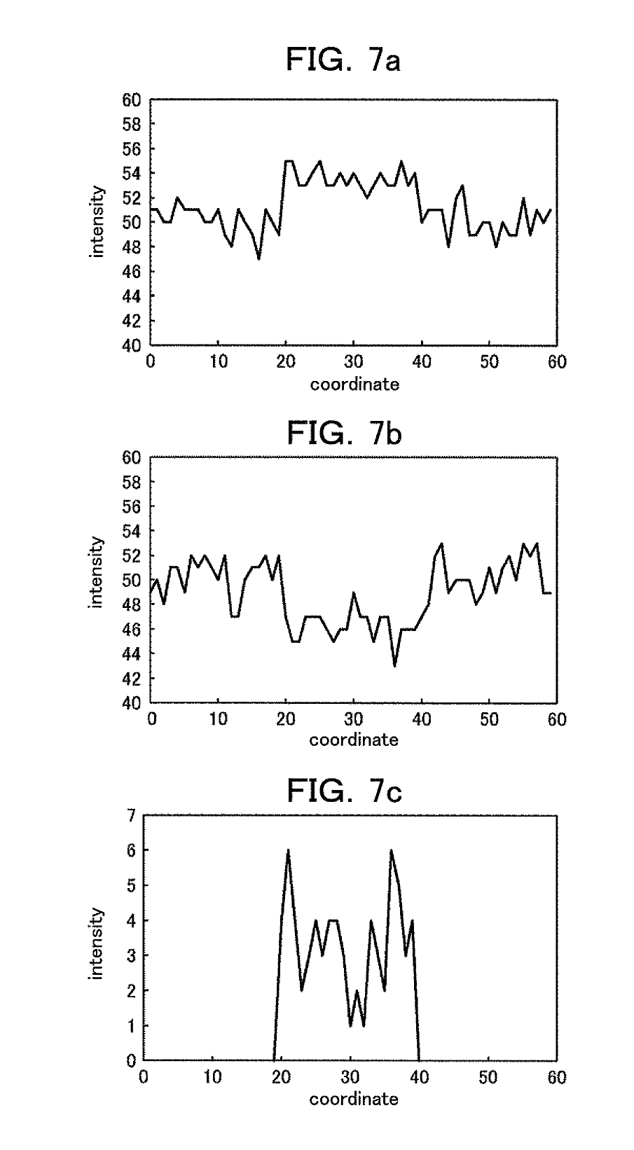

With reference to FIGS. 7A-7C, the calculation method will be explained. Provided that, when operating in the X direction with the Y-coordinate fixed, a wave form such as FIG. 7A in which the pattern parts (coordinates 20 through 40) look bright compared to the vicinity parts in a certain wavelength band, and a wave form such as FIG. 7B in which the pattern parts look dark compared to the vicinity parts in the other wavelength band are obtained. It is possible to easily calculate the standard deviations σa, σb of the noises of these wave forms, from the camera characteristics and the intensity average values at the time.

At this time, to the wave form in FIG. 7B, adding the offset of σa+σb and subtracting from the wave form in FIG. 7A result in the acquisition of the wave form in FIG. 7C. That is to say, signals to completely eliminate the noises of the vicinity parts and to leave the pattern parts only are obtained. This time, for the simplicity, an explanation has been made as the wave form, however, the similar operations can be performed when viewing the images, therefore, it is possible to obtain the observation images to have eliminated the noises of the vicinity parts.

By configuring the alignment measuring device 400 as aforementioned, it becomes possible to easily obtain the images with high contrasts, and possible to perform the alignment stably. Furthermore, two or more kinds of wavelength bands are used in order to acquire the images, therefore, it is possible to reduce risks of the decreased contrasts by the variations of the film thicknesses. Incidentally, in the above embodiment, the combination has only a single pattern of the registration, however, the alignment can be stabilized, in the case that there are a plurality of combinations possibly to obtain high contrasts, by storing several, and in the case that the alignment could not be performed normally in one combination, by performing in the other combination, or the like.

In the above embodiment, an explanation has been made for the case that the white light has been used for the light source and has been separated to the wavelength bands in the prism, however, the images of different wavelength bands may be acquired in a time-sharing manner by utilizing two kinds of light sources with different wavelength bands as the light source, or the images may be acquired by preparing a plurality of filters in the optical paths and switching. At this time, for the light sources or filters to be used, by utilizing the light sources with isolated and narrow wavelength bands (for example, two lasers are used for the light source or the like) or filters which can narrow the wavelength band in principle by calculation-processing (for example, filters with the same penetration ratio of the mutually common penetration wavelength), the high effectiveness can be expected.

Furthermore, by differential-processing the acquired images and calculating, it becomes possible to display the edges being emphasized.

### EXPLANATION OF REFERENCES

1 wafer
2 chip
2a alignment mark of a first chip
2b alignment mark of a second chip
10 illumination means
20 detection means (20a image-formation means, 20b light-receiving means)
30 X scale
40 Y scale
50 illumination section of surface height position detection system
60 (2 pieces for 1 set: 60a, 60b) detection section of surface height position detection system
100 processing apparatus
110 A/D converter
120 foreign substance detection image processing unit
121 image comparison circuit
122 threshold calculation circuit
123 threshold storage circuit
130 foreign substance determination unit
131 determination circuit
132,133 coefficient tables
140 coordinate control unit
150 inspection result storage unit
200 stage Z control device
300 image display device
400 alignment measuring device
401 light source
407 prism
408, 409, 410 CCD cameras
411 calculation-processing section
412 external storage section
501 acquired image
502 check box
503 calculation result image
504 image display button
505 storage, execution button

1. An inspection apparatus, comprising:
an alignment measuring device, wherein,
the alignment apparatus comprises
a light source for irradiating light to an object,
an image-formation optical system for image-forming light from the object,
an imaging device for acquiring an image image-formed by the image-formation optical system, and
an image processing unit for processing an image acquired by the imaging device; and
the image processing unit heightens contrast by detecting the light of at least two different wavelength bands with the imaging device and calculating a plurality of acquired images.

2. The inspection apparatus of claim 1, further comprising a light source for emitting light of at least two different wavelength bands and for detecting the light corresponding to the wavelength bands.

3. An inspection method for heightening contrast by irradiating light to an object, acquiring an image of the object, and mutually calculating a plurality of the images.

4. The inspection method of claim 3, wherein the light is light of at least two different wavelength bands.
